(19) United States
(12) Patent Application Publication
(10) Pub. No.: US 2011/0164070 A1
(43) Pub. Date: Jul. 7, 2011

(54) DISPLAY MODULE

(75) Inventors: James Sirmon, Middlesex (GB); Anthony Cole, Bristol (GB)

(73) Assignee: LITELOGIC IP LIMITED, London (GB)

(21) Appl. No.: 12/737,607

(22) PCT Filed: Jul. 29, 2009
(86) PCT No.: PCT/GB2009/050939

§ 371 Date: Mar. 16, 2011

(30) Foreign Application Priority Data
Jul. 29, 2008 (GB) 0813807.5

(51) Int. Cl. G09G 5/10

(52) U.S. Cl. 345/690

(57) ABSTRACT

A display module is disclosed, which comprises at least one light source movable along a predetermined path and a controller adapted to modulate the intensity of light emitted by the at least one light source as it moves along the predetermined path so as to cause a desired image to be visible by virtue of persistence of vision. The display module further comprises a drive system for causing the at least one light source to move along the predetermined path and a coupling system adapted to ensure the drive system causes the at least one light source to move, in use, along the predetermined path in synchrony with the light sources on one or more adjacent display modules.

This invention relates to displays of the type in which light sources are movable along a predetermined path and the intensity of light emitted by the light sources as they move along the predetermined path is varied in order to cause a desired image to be visible by virtue of persistence of vision.

Such types of display are well known, but they have typically been used only as novelty amusement devices. However, we have found that these types of display device may be used to generate high quality static and video images. One way of achieving this is set out in our PCT application, published as WO2006/021788. This describes an image display apparatus comprising two or more arrays of light sources which rotate around a common axis. The intensity of light emitted by each light source as it rotates around the common axis is modulated so that the light sources in combination cause a desired image to be visible to an observer by virtue of persistence of vision.

In the display system described in WO2006/021788, each light source is arranged such that it traverses along a unique path, the unique paths of the light sources in each array being interlaced with those of the other arrays. Although this feature is not an essential part of the invention described herein, it does provide a particular benefit in that the resolution of the display may be increased almost arbitrarily such that relatively few light sources may be used to render an extremely large number of “virtual pixels”. This feature makes the use of this type of display very cost-effective for large scale display applications, such as in advertising billboards and video displays at public events and the like.

There are some difficulties with using this type of display however, because many different sizes of display are required for different purposes. Therefore, the arrays of light sources have to be sized to suit the particular application. This is costly in terms of the cost of designing and manufacturing bespoke arrays to suit a particular application. It also presents engineering difficulties since in the case of large displays the speed of motion at the tip of an array will be alarmingly high in order to ensure a sufficient refresh rate closer to the centre of the array, and the rotation of the arrays at high speed inevitably causes vibration unless the arrays are well balanced, which of course leads to image distortion amongst other problems.

Another problem that exists with this type of system is that as the arrays are rotated around the common axis, the light sources describe a circular path. The resulting image is therefore inevitably circular in nature, whereas the vast majority of display applications require the image displayed to have a rectangular or square format.

In one aspect of the invention, a display module comprises at least one light source movable along a predetermined path and a controller adapted to modulate the intensity of light emitted by the at least one light source as it moves along the predetermined path so as to cause a desired image to be visible by virtue of persistence of vision, characterised in that the display module further comprises a drive system for causing the at least one light source to move along the predetermined path and a coupling system adapted to ensure that the drive system causes the at least one light source to move, in use, along the predetermined path in synchrony with the light sources on one or more adjacent display modules.

The invention therefore overcomes the problems associated with bespoke designs of display modules mentioned above. The modular approach adopted allows a single design of module to be used for the construction of display assemblies of a vast array of different sizes and shapes without requiring any particular engineering or development work. Since the module may be much smaller than the overall size of the assembly, the speed of rotation of the individual modules may be lower, thereby reducing the vibration that would otherwise be encountered.

In one embodiment, the at least one light source comprises an array of light sources rotatable around a common axis, the light sources in the array being arranged such that each traverses along a unique path around the common axis, and the controller is adapted to modulate the intensity of light emitted by each light source in the array as it traverses its respective unique path such that the light sources in combination cause a desired image to be visible by virtue of persistence of vision.

However, in a preferred embodiment, the at least one light source comprises two or more arrays of light sources, each array being rotatable around a common axis, the light sources in each array being arranged such that each traverses along a unique path around the common axis, and the controller is adapted to modulate the intensity of light emitted by each light source as it traverses its respective unique path such that the light sources in combination cause a desired image to be visible by virtue of persistence of vision.

In this preferred embodiment, the arrays preferably rotate around the common axis in synchrony.

This preferred embodiment may comprise two arrays which are diametrically opposed as they rotate around the common axis. However, it typically comprises four arrays, equidistantly disposed around the common axis.

The paths traversed by the light sources of each array in this preferred embodiment may be interlaced.

The module may further comprise a central array of light sources disposed radially inwardly from the first array with its centre on the common axis.

The module typically further comprises a Hall effect sensor coupled to the controller, the Hall effect sensor being adapted to sense the passage of a magnet mounted on one of or each of the arrays. The provision of a Hall effect sensor enables the controller to keep track of the position of the arrays as they rotate around the common axis. The sensing of the passage of the magnet provides an index position where the arrays are at a predetermined angle of rotation around the common axis. The position of the arrays at any time can be determined from the angular speed of the arrays and the time since the passage of the magnet was last detected. The angular speed may either be controlled by a speed controller or calculated based on the time taken between consecutive passages of the magnet past the Hall effect sensor. Although other sensing means, such as an optical encoder, may be used to determine the position of the arrays the use of a Hall effect sensor has the advantages that it is relatively immune to dust, dirt and water. In other variants, an optical sensor may replace the Hall effect sensor, the optical sensor detecting the passage of an element between an optical transmitter and an optical receiver.

The light sources are typically light emitting diodes (LEDs), and preferably the LEDs are tricolour LEDs.

In one embodiment, the drive system comprises a plurality of synchronising shafts coupled together and to the at least one light source such that rotation of any one synchronising shaft causes the others to rotate and the at least one light source to move along the predetermined path and the coupling system comprises a coupling on each synchronising shaft, whereby each synchronising shaft can be coupled, in use, to a synchronising shaft of an adjacent display module, thereby ensuring that the light sources on each module move in synchrony.

The synchronising shafts are typically coupled together and to the at least one light source by a gear linkage.

This gear linkage may comprise a plurality of bevel gears, each of which is mounted on one end of a respective one of the plurality of synchronising shafts and is meshed with another bevel gear coupled to the at least one light source.

The at least one light source may be coupled to the plurality of synchronising shafts via a clutch such that when the clutch is disengaged the at least one light source may move along the predetermined path without corresponding movement of the plurality of synchronising shafts.

Preferably, the clutch may only be engaged when the at least one light source is at one of a plurality of index positions along the predetermined path and the plurality of synchronising shafts are at a predetermined angle of rotation.

The display module typically further comprises an electrical connection which may be coupled in use to an adjacent module for transmitting image data to the adjacent module.

The display module normally further comprises a housing in which the plurality of synchronising shafts are mounted, the housing comprising a front face and at least one peripheral face defining the perimeter of the housing, wherein an end of each synchronising shaft is exposed through a respective aperture in the at least one peripheral face.

The at least one light source is typically coupled to the plurality of synchronising shafts via a driven shaft which passes through an aperture in the front face.

The at least one light source is typically disposed adjacent the front face on the outside of the housing.

Preferably, the at least one light source is covered by a transparent cover.

The front face and at least one peripheral face typically intersect to form an edge.

In a first embodiment, the front face and at least one peripheral face are typically disposed at right angles.

In a preferred second embodiment, the front face of the housing is shaped such that a plurality of housings may be placed with their peripheral edges in abutment to form a tessellation. In this case, the front face of the housing typically has a triangular, square or hexagonal shape.

A display assembly may be constructed, in which the peripheral edges of a plurality of display modules according to the first and second embodiments are placed in abutment with those of adjacent display modules to form a tessellation, and the synchronising shafts of each display module are coupled such that the light sources of each display module all rotate in synchrony.

In this display assembly, the controller of each display module is typically electrically connected to the controller of an adjacent display module to enable transmission of image data from each display module to the adjacent display module.

The position of the at least one light source of each display module is typically offset along its respective predetermined path relative to the position of the at least one light source of adjacent display modules. This ensures that the light sources of adjacent display modules do not collide as they rotate. The at least one light source of each display module typically rotates in an opposite direction to the direction of rotation of adjacent display modules for the same reason.

Preferably, each display module may be slidably moved in a direction perpendicular to its front face relative to adjacent display modules, thereby enabling replacement of the module.

In a particularly preferred embodiment, the drive system comprises a motor coupled to the at least one light source and the coupling system comprises a speed controller for controlling the speed of rotation of the at least one light source and/or the angular offset of the at least one light source relative to an absolute synchronisation point in accordance with a master clock signal.

Normally, the motor comprises a static shaft about which the at least one light source is rotatable in use.

The shaft may be hollow and the module may further comprise an optical transmitter and an optical receiver which cooperate to convey image data from an image data source to the controller, the optical transmitter and optical receiver being disposed in alignment with each other at either end of the hollow shaft such that the image data can be transmitted by the optical transmitter to the optical receiver through the hollow shaft.

Preferably, the module further comprises a first sensor adapted to generate an output pulse in response to the passage of each of an array of circumferentially-spaced speed control elements as the at least one light source rotates, the speed control elements being equidistantly spaced from each other, wherein the speed controller is adapted to control the speed of rotation of the motor such that the output pulses generated by the sensor and the master clock signal are synchronised.

The display module may comprise a second sensor for detecting the passage of a location element, thereby enabling each revolution of the at least one light source to be detected.

Typically, the module further comprises a peripheral ring of gear teeth coupled to the motor, which interdigitate in use with the gear teeth on the rotors of adjacent modules. These gear teeth are preferably configured such that they do not make contact in use with the gear teeth of adjacent modules when the light sources of adjacent modules are rotating in synchrony.

The module normally further comprises interconnection features for interconnecting the display module with adjacent display modules in a predefined registration and orientation.

The interconnection features preferably comprise a pair of male features on each of a first pair of diagonally opposed corners of the module and a pair of female features on each of a second pair of diagonally opposed corners of the module, whereby the male and female features cooperate with the female and male features respectively on adjacent modules to hold the adjacent modules in the predefined registration and orientation.

A display assembly may be formed, in which the interconnection features of a plurality of display modules are interconnected with those of adjacent modules, and each display module is supplied with the master clock signal such that the light sources of each display module rotate in synchrony.

In this case, the controller of each display module may be electrically connected to the controller of an adjacent display module to enable transmission of image data from each display module to the adjacent display module.

Within the assembly, the position of the at least one light source of each display module may be offset along its respective predetermined path relative to the position of the at least one light source of adjacent display modules.

Typically, each display module in the assembly may be slidably moved in a direction perpendicular to the plane in which the predetermined path lies relative to adjacent display modules, thereby enabling replacement of the module.

In a second aspect of the invention, a display device comprises a first light source movable along a first predetermined path having a first shape, a second light source movable along a second predetermined path having a second shape, and a controller adapted to modulate the intensity of light emitted by the first and second light sources as they move along the first and second predetermined paths respectively so as to cause a desired image to be visible by virtue of persistence of vision.

The invention therefore overcomes the problem whereby circular rather than square or rectangular images are produced. By ensuring that the second light source follows a different shape of path to the first light source, the image boundary may have, for example, a rectangular shape even though a circular rotary motion is used to cause the motion of the light sources.

Typically, the second predetermined path encloses the first predetermined path.

In one embodiment, the first light source is one of a first array of light sources and the second light source is one of a first auxiliary array of light sources, each of the first array and the first auxiliary array being rotatable around a common axis, the light sources in the first array and first auxiliary array being arranged such that each traverses along a unique path around the common axis, the light sources in the first auxiliary array being movable relative to the light sources in the first array such that the unique paths traversed by the light sources in the first array are of the first shape and the light sources in the first auxiliary array are of the second shape, and the controller is adapted to modulate the intensity of light emitted by each light source in the first array and first auxiliary array as they traverse their respective unique paths such that the light sources in combination cause a desired image to be visible by virtue of persistence of vision.

Typically, the first array and first auxiliary array rotate around the common axis in synchrony.

Typically, the first array and first auxiliary array rotate around the common axis in radial alignment.

In a preferred embodiment, the first auxiliary array is radially movable relative to the first array.

Typically, the first array is mounted on a first printed circuit board (PCB) and the first auxiliary array is mounted on a first auxiliary PCB, the first auxiliary PCB being slidable relative to the first PCB. In this case, the first auxiliary PCB is normally slidably mounted on the first PCB.

In one variant, the first auxiliary PCB is caused to slide relative to the first PCB by following a cam profile as it rotates around the common axis.

In another variant, the first auxiliary PCB is caused to slide relative to the first PCB by a motor coupled to the first auxiliary PCB and driven by the controller so as to vary the displacement of the first auxiliary PCB relative to the first PCB as it rotates around the common axis.

A preferred embodiment further comprises a second array of light sources and a second auxiliary array of light sources, each of the second array and the second auxiliary array being rotatable around a common axis, the light sources in the second array and the second auxiliary array being arranged such that each traverses along a unique path around the common axis, the light sources in the second auxiliary array being movable relative to the light sources in the second array such that the unique paths traversed by the light sources in the second array are of the first shape and the light sources in the second auxiliary array are of the second shape, the controller being adapted to modulate the intensity of light emitted by each light source as it traverses its respective unique path such that the light sources of the first and second array and the first and second auxiliary arrays in combination cause a desired image to be visible by virtue of persistence of vision.

The second array and second auxiliary array typically rotate around the common axis in synchrony.

The second array and second auxiliary array typically rotate around the common axis in radial alignment.

Typically, the first array and second array rotate around the common axis in synchrony.

Typically, the first auxiliary array and second auxiliary array rotate around the common axis in synchrony.

The first array and the first auxiliary array may be diametrically opposed to the second array and the second auxiliary array as they rotate around the common axis.

Preferably, the paths traversed by the light sources of each of the first and second arrays are interlaced and the paths traversed by the light sources of each of the first and second auxiliary arrays are interlaced.

The second auxiliary array is typically radially movable relative to the second array.

Preferably, the second array is mounted on a second PCB and the second auxiliary array is mounted on a second auxiliary PCB, the second auxiliary PCB being slidable relative to the second PCB. In this case, the second auxiliary PCB is typically slidably mounted on the second PCB.

In one variant, the second auxiliary PCB is caused to slide relative to the second PCB by following a cam profile as it rotates around the common axis.

In an alternative variant, the second auxiliary PCB is caused to slide relative to the second PCB by a motor coupled to the second auxiliary PCB and driven by the controller so as to vary the displacement of the second auxiliary PCB relative to the second PCB as it rotates around the common axis.

The device typically further comprises a central array of light sources disposed radially inwardly from the first array with its centre on the common axis.

Preferably, the device further comprises a Hall effect device coupled to the controller, the Hall effect device being adapted to sense the passage of a magnet mounted on the first array. As already discussed in relation to the first aspect of the invention, the provision of a Hall effect sensor enables the controller to keep track of the position of the arrays as they rotate around the common axis. In other variants, an optical sensor may replace the Hall effect sensor, the optical sensor detecting the passage of an element between an optical transmitter and an optical receiver.

Typically, the light sources are LEDs, and preferably the LEDs are tricolour LEDs.

Normally, the first shape is a circle and the second shape is a square or a rectangle.

In a third aspect of the invention, there is a method of mapping image data on to a first array of light sources rotatable around a common axis, the light sources in the first array being arranged such that each traverses along a unique path around the common axis, the intensity of light emitted by each light source in the first array being modulated as it traverses its respective unique path such that the light sources in combination cause a desired image to be visible by virtue of persistence of vision, and the image data comprising a plurality of data values, each of which corresponds to a pixel in the desired image, the method comprising the following steps:

a) monitoring the position of the first array and assigning each light source in the first array to an appropriate pixel in the desired image;

b) calculating the point of intersection of the first array with a predefined image boundary;

c) modulating the intensity of each light source of the first array within the predefined boundary according to the data values corresponding to the pixels of the desired image to which the light sources have been assigned in step (a);

d) modulating the intensity of each light source outside the predefined boundary according to modified data values corresponding to the pixels of the desired image to which the light sources have been assigned in step (a), the modified data values being calculated from the corresponding data values in accordance with a predetermined function; and

e) repeating steps (a) to (d) as the first array rotates around the common axis.

This provides another way of overcoming the problem whereby circular rather than square of rectangular images are produced. By switching off or reducing the intensity of LEDs that fall outside the predefined image boundary, the generated image may be forced to have, for example, a rectangular shape even though a circular rotary motion is used to cause the motion of the light sources.

The image data may also be mapped on to a second array of light sources, the second array being rotatable around the common axis, the light sources in the second array being arranged such that each traverses along a unique path around the common axis, and the intensity of light emitted by each light source being modulated as it traverses its respective unique path such that the light sources of the first and second array in combination cause a desired image to be visible by virtue of persistence of vision, the method comprising the following additional steps:

i) monitoring the position of the second array and assigning each light source in the second array to an appropriate pixel in the desired image;

ii) calculating the point of intersection of the second array with the predefined image boundary;

iii) modulating the intensity of each light source of the second array within the predefined boundary according to the data values corresponding to the pixels of the desired image to which the light sources have been assigned in step (i);

iv) modulating the intensity of each light source outside the predefined boundary according to modified data values corresponding to the pixels of the desired image to which the light sources have been assigned in step (i), the modified data values being calculated from the corresponding data values in accordance with a predetermined function; and

v) repeating steps (i) to (iv) as the first array rotates around the common axis.

In this case, steps (i) to (v) will typically be carried out concurrently with steps (a) to (e).

The first and second arrays typically rotate around the common axis in synchrony. In this case, the first and second arrays are normally diametrically opposed as they rotate around the common axis.

The paths traversed by the light sources of each array are preferably interlaced.

The position of the first array is typically monitored in step (a) by detecting the passage of a magnet mounted on the first array using a Hall effect device. As already discussed in relation to the first and second aspects of the invention, the provision of a Hall effect sensor enables the controller to keep track of the position of the arrays as they rotate around the common axis. In other variants, an optical sensor may replace the Hall effect sensor, the optical sensor detecting the passage of an element between an optical transmitter and an optical receiver.

When present, the position of the second array may be monitored in step (i) by detecting the passage of a magnet mounted on the second array using a Hall effect device. In other variants, an optical sensor may replace the Hall effect sensor, the optical sensor detecting the passage of an element between an optical transmitter and an optical receiver.

Alternatively, the position of the second array may be monitored in step (i) by detecting the passage of a magnet mounted on the first array using a Hall effect device. This is enabled by knowledge of the angular displacement of the second and first arrays. In other variants, an optical sensor may replace the Hall effect sensor, the optical sensor detecting the passage of an element between an optical transmitter and an optical receiver.

Typically, the first and/or second array rotates around the common axis at a constant angular velocity.

The predefined image boundary is typically square or rectangular in shape.

The predefined image boundary is normally contained entirely within the area swept out by the first and/or second array.

In one embodiment, the predetermined function multiplies the data values outside the predefined image boundary by zero such that the corresponding modified data values are all zero.

In an alternative embodiment, the predetermined function causes the intensity of the modified data values outside the predefined image value to be reduced relative to the intensity of the corresponding data values.

In a further alternative embodiment, the predetermined function causes the intensity of the modified data values outside the predefined image value to fade in accordance with their distance from the predefined image boundary.

In a fourth aspect of the invention, there is provided a computer program comprising computer-implementable instructions, which when executed by a programmable computer causes the programmable computer to perform a method in accordance with the third aspect of the invention.

In a fifth aspect of the invention, there is provided a computer program product comprising a computer program, which when executed by a programmable computer causes the programmable computer to perform a method in accordance with the third aspect of the invention.

Embodiments of the invention will now be described with reference to the accompanying drawings, in which:

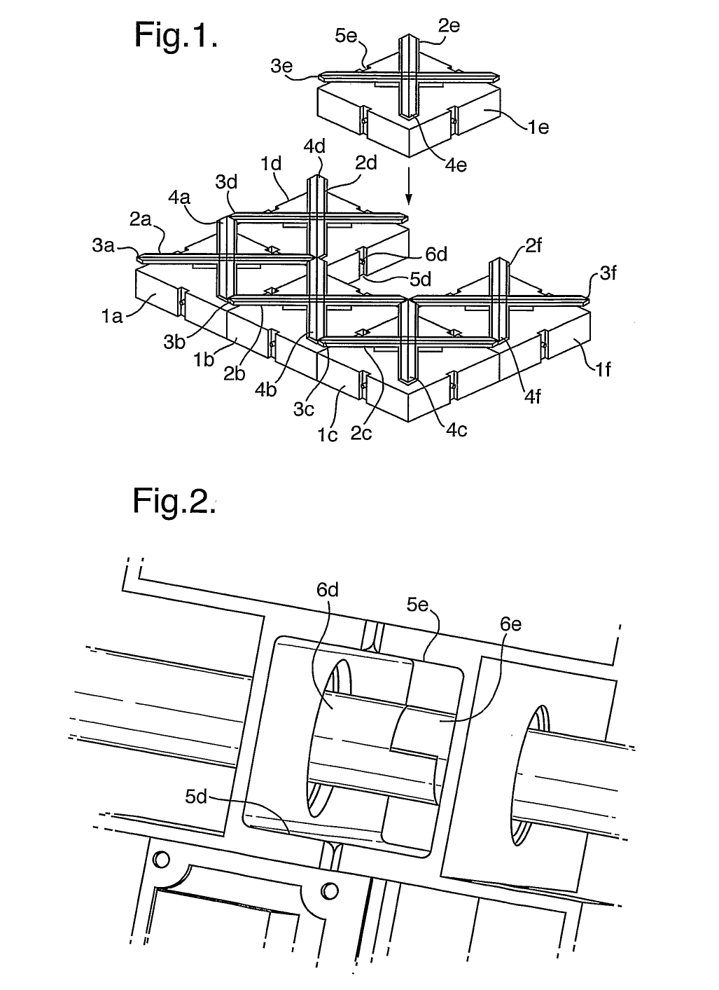

FIG. 1 shows an assembly of display modules according to a first embodiment of the invention.

FIG. 2 shows the drive coupling between a pair of adjacent modules within the assembly.

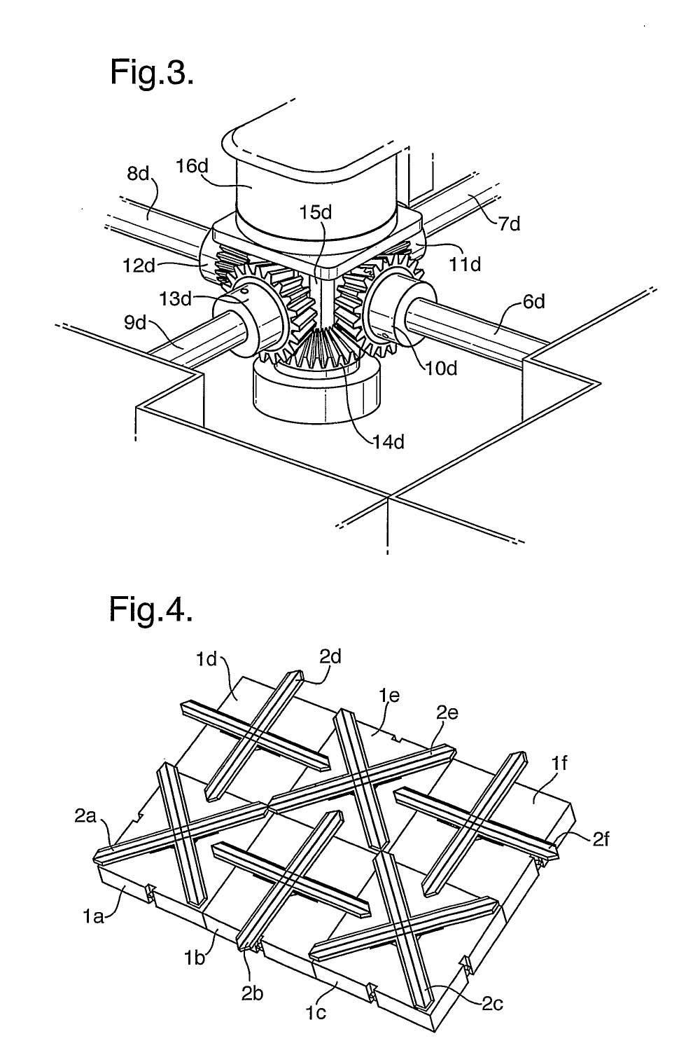

FIG. 3 shows a gear linkage within one of the modules.

FIG. 4 shows the assembly of six modules configured for operation.

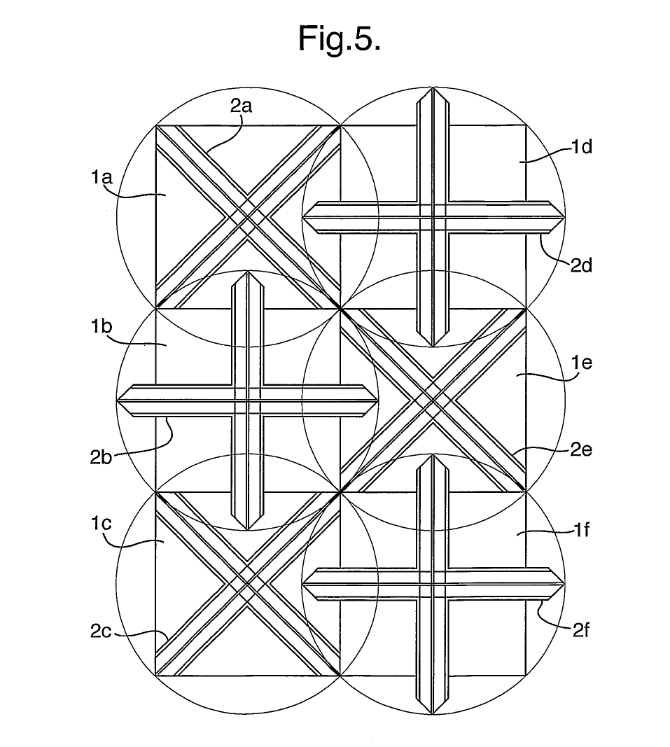

FIG. 5 shows a front view of the assembly.

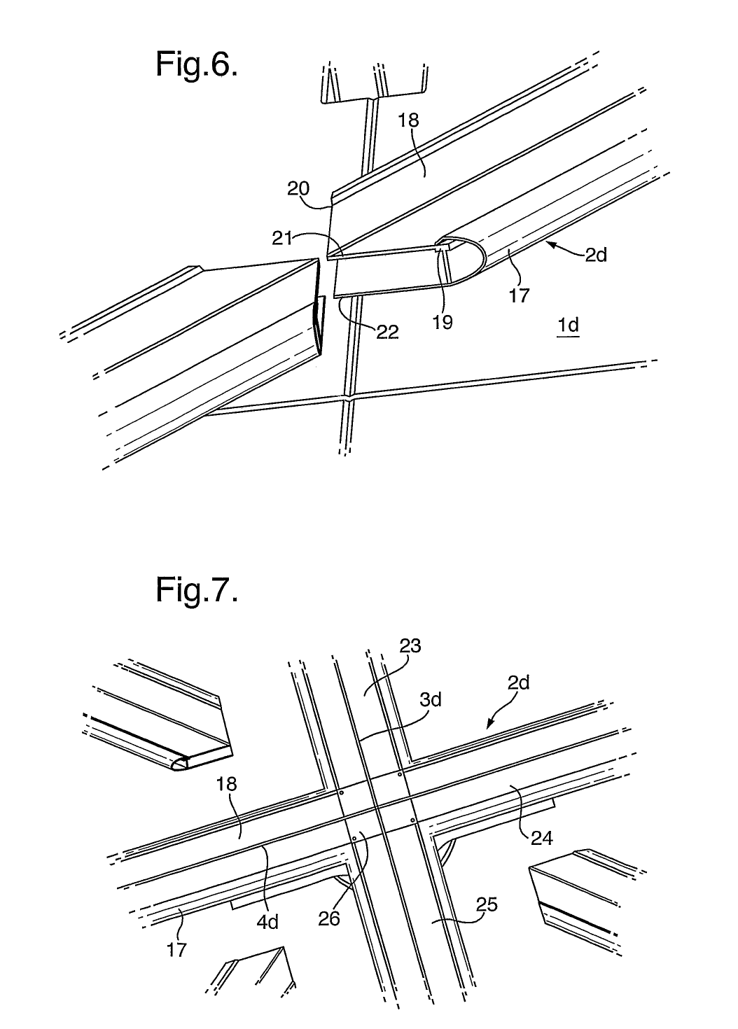

FIG. 6 shows a detailed view of the outer ends of one of the printed circuit board carrying the light emitting diodes.

FIG. 7 shows a detailed view of the centre of the rotating blade assembly.

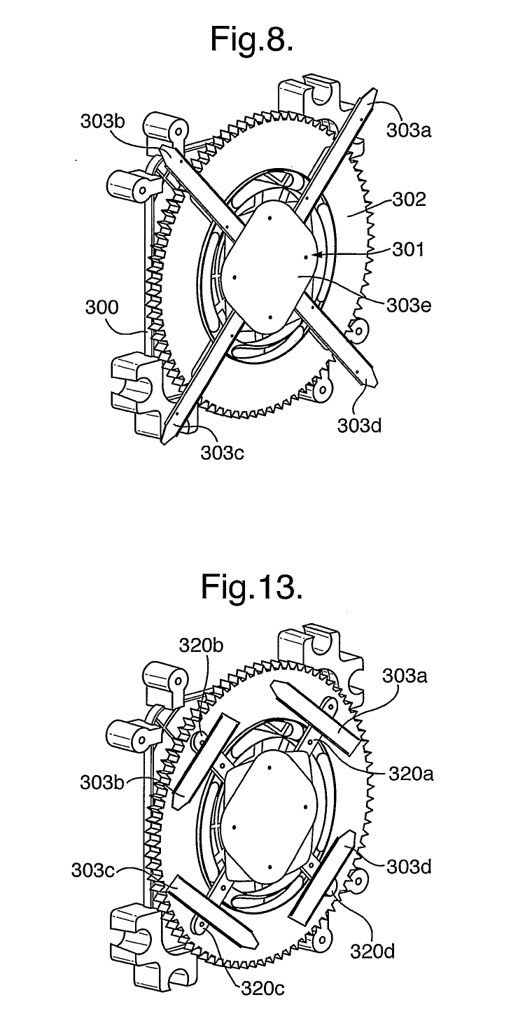

FIG. 8 shows a perspective view of a display module according to a second embodiment of the invention.

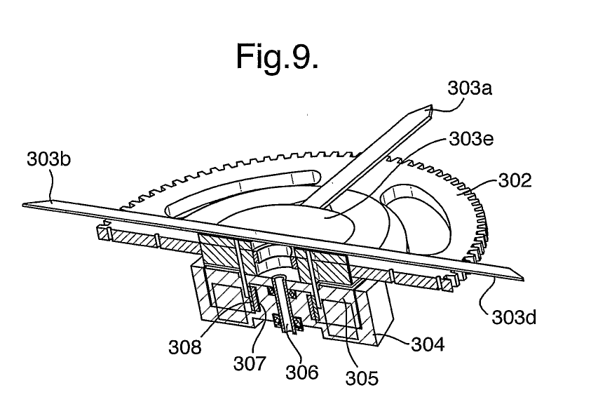

FIG. 9 shows a sectional view through the display module.

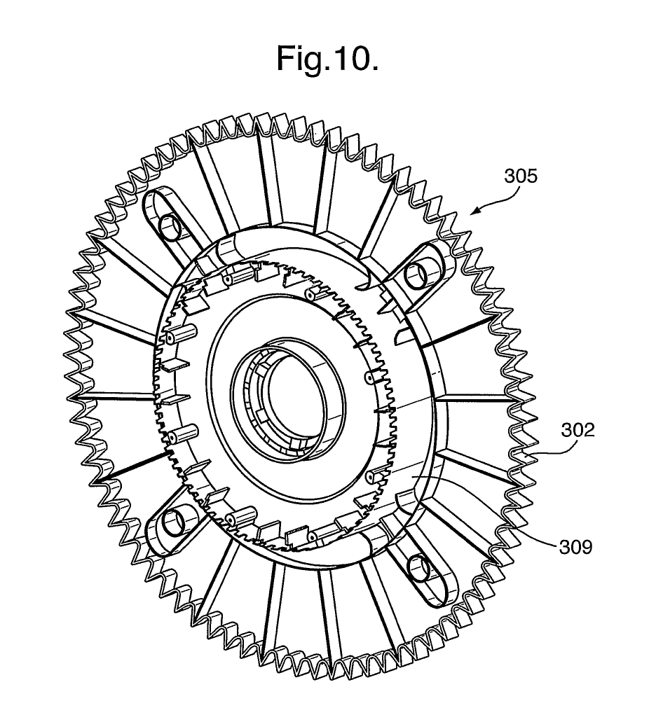

FIG. 10 shows a view of the rotor of the display module in isolation.

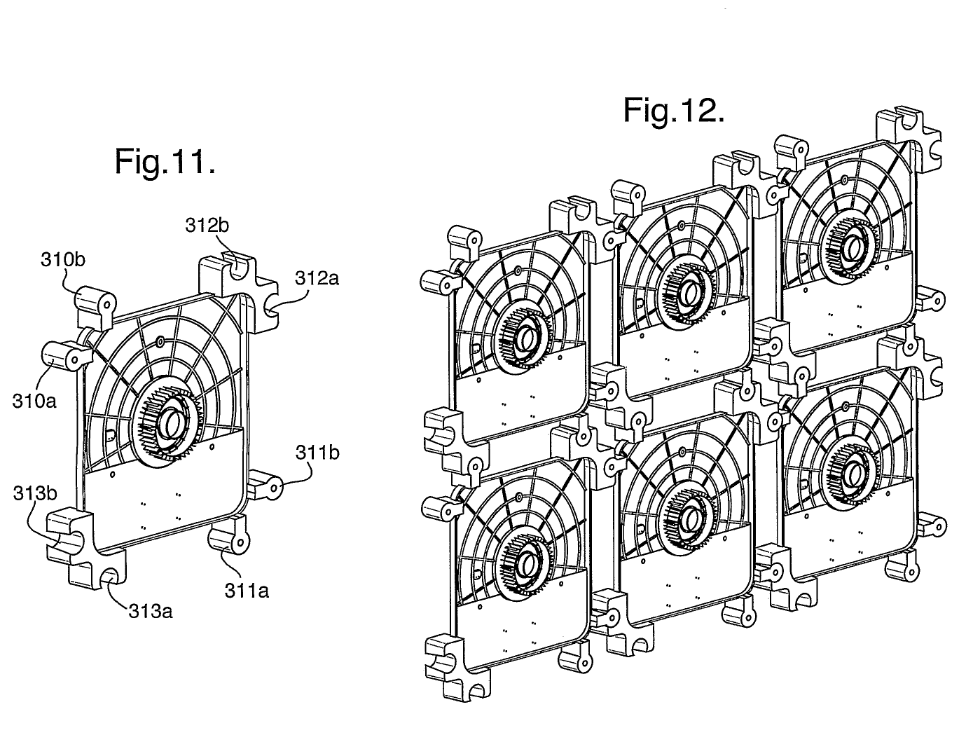

FIG. 11 shows a view of the stator of the display module in isolation.

FIG. 12 shows a view of six stators joined together to illustrate how a display assembly may be constructed.

FIG. 13 shows a perspective view of the module with the radial arm PCBs folded in.

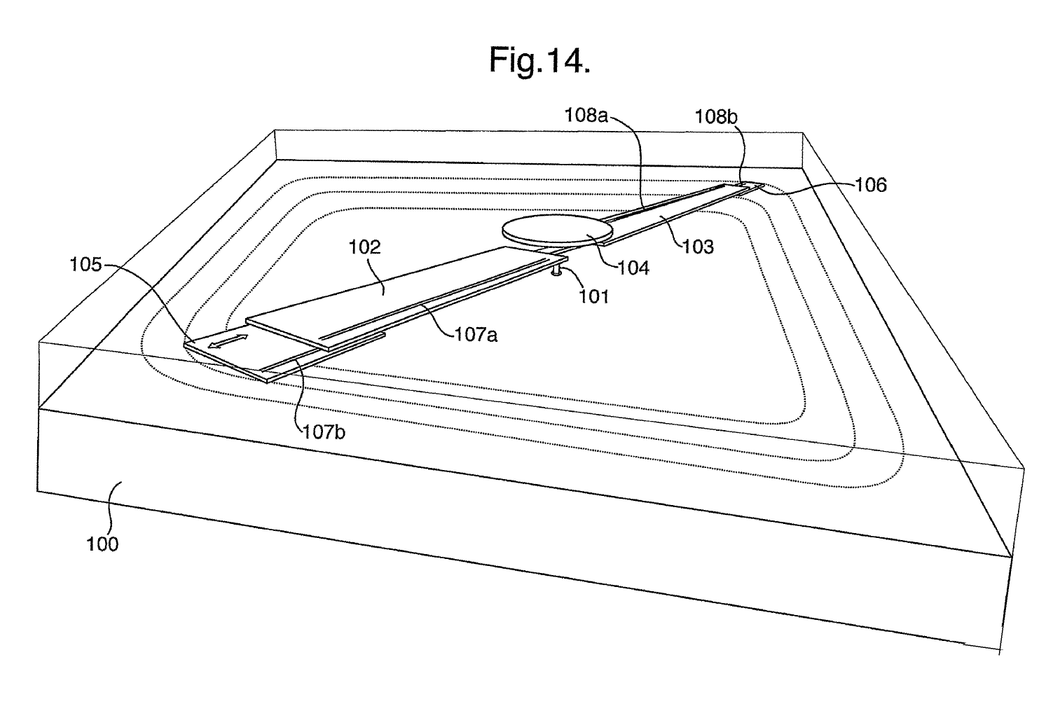

FIG. 14 shows a display module modified so as to produce an image with a square or rectangular format.

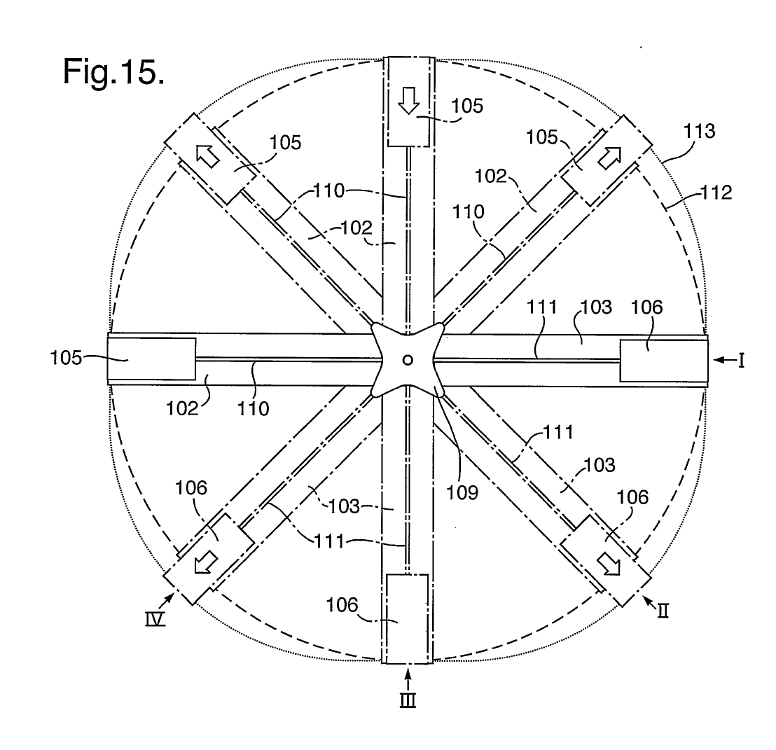

FIG. 15 shows schematically a rear view of the display module of FIG. 14.

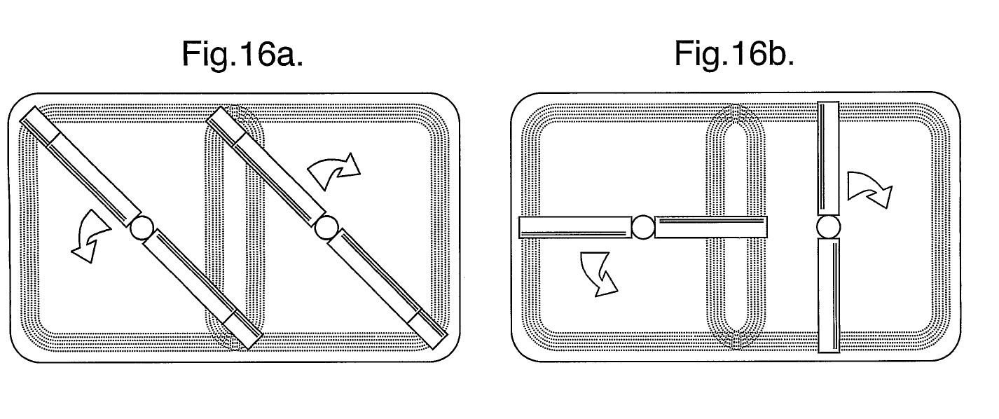

FIGS. 16a and 16b show front views of the display module of FIG. 14.

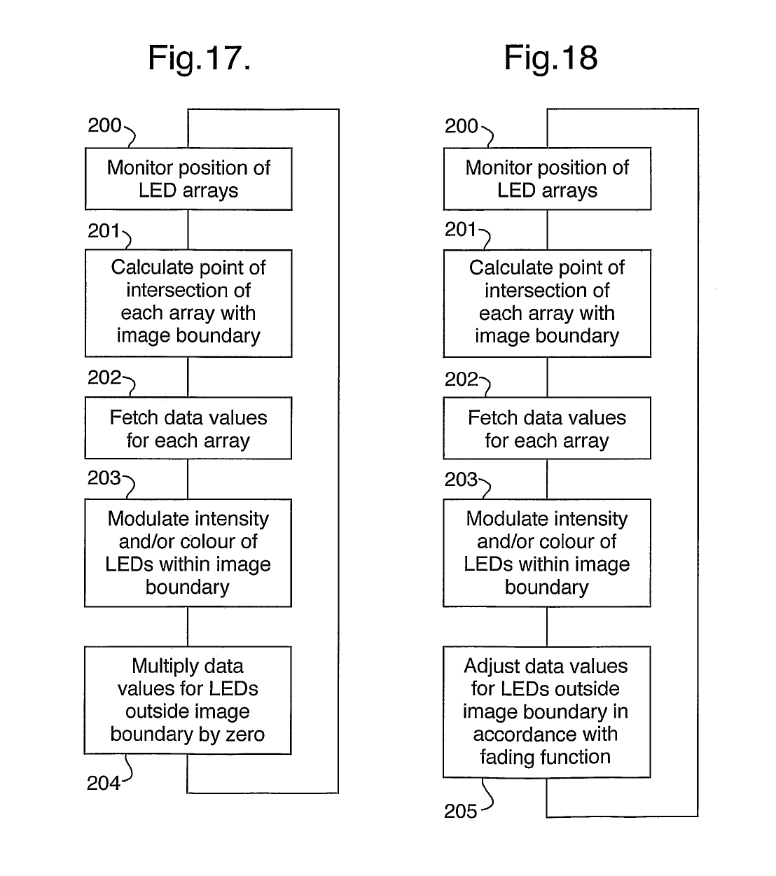

FIG. 17 shows a flow diagram for a first method of adjusting the image format electronically.

FIG. 18 shows a flow diagram for a second method of adjusting the image format electronically.

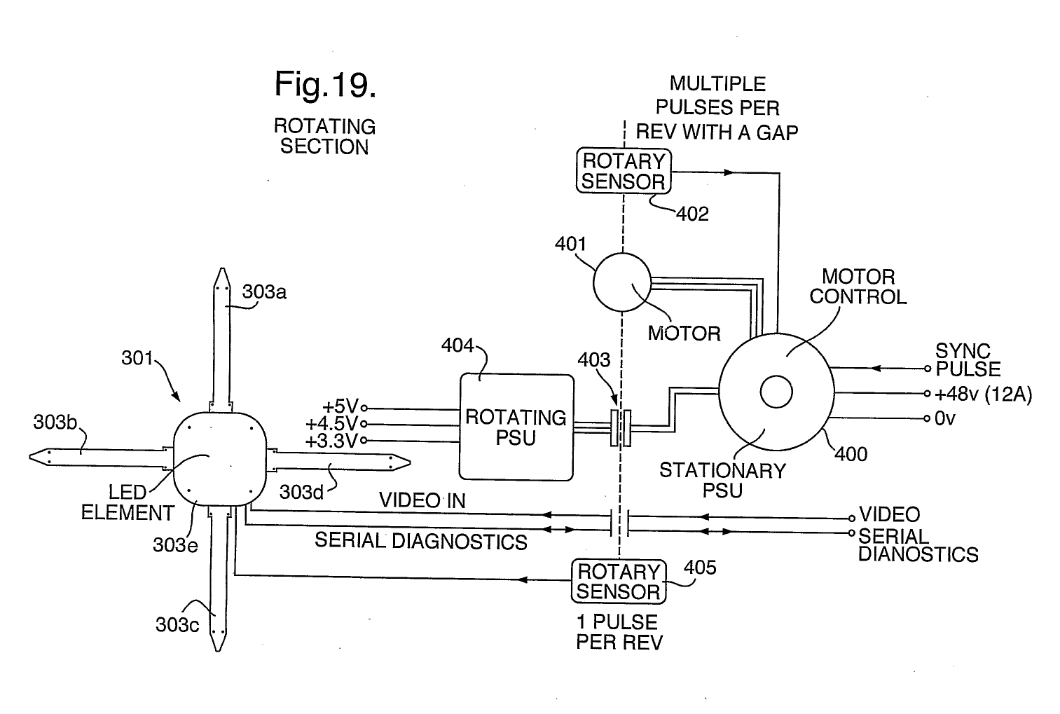

FIG. 19 shows a schematic block diagram of the electronic circuitry used in the second embodiment.

FIG. 1 shows an assembly of six display modules, each of which is identical. Each of the six modules comprises a housing 1a to 1f and a blade assembly 2a to 2f. The blade assembly 2a to 2f will be described in detail later, but briefly it carries a set of printed circuit boards (PCBs). An array of light emitting diodes (LEDs) is mounted on each PCB in such a manner that when the PCBs are mounted on blade assemblies 2a to 2f the arrays form a respective pair of lines of LEDs 3a to 3f and 4a to 4f, which intersect at the centre of the blade assembly 2a to 2f to form a cross. The blade assemblies 2a to 2f are rotatably mounted on their respective housings 1a to 1f, and the intensity and/or colour of the light emitted by the LEDs may be varied as the blade assemblies 2a to 2f rotates such that the LEDs in combination cause a desired image to be visible by virtue of persistence of vision.

The housings 1a to if have a square front face, of which the dimensions are typically 600 millimetres by 600 millimetres. As can be seen from FIG. 1, the blade assembly 2a is sized such that the outermost LEDs of the two lines of LEDs 3a to 3f and 4a to 4f align with the corners of the square front face of housings 1a to 1f. Hence, the total span of the blade assembly is 848.5 millimetres. These dimensions have been selected as a suitable size for use in advertising applications, where traditionally advertising posters or “sheets” were placed together. Each “sheet” is two feet on each side, and the size of an advertisement is specified in terms of the number of “sheets” used to form it. For example, a “six-sheet” advertisement would have six “sheets” arranged in a 2×3 format.

The assembly of modules in FIG. 1 can be used as an alternative to a traditional “six-sheet” poster based advert. The slight difference in dimension between 600 millimetres and two feet is largely immaterial for fairly small applications such as a six-sheet display, but in larger applications such as a 96-sheet display the difference may become more noticeable. It might therefore be preferable for some applications to have a module size of exactly two feet by two feet or in metric 609.6 millimetres by 609.6 millimetres.

Each module may be placed adjacent to other modules so as to create an overall display configuration of almost arbitrary size and shape. To make up the display configuration, each of the modules is bolted to a framework situated behind the modules, thereby retaining the modules in the correct positions with respect to each other.

Each module may be removed from its position in order to ease servicing, and a replacement module may be introduced into any vacant position such as is shown in FIG. 1 in which the housing 1e may be moved in the direction of arrow A so as to fill the vacant space between housings 1d and 1f. The removal and replacement operations may be made without disturbing any of the adjacent modules. Removal simply involves undoing the retaining bolts securing the module to the framework and withdrawing it from the assembly, with replacement simply being the reverse of this.

As is clearly seen in FIG. 1, each side of each housing has a recess. At each recess the end of a respective synchronising shaft is exposed. Each of the modules shown in FIG. 1 therefore has four synchronising shafts. The four synchronising shafts and the blade assembly are all coupled together within the housing by a gear linkage such that rotation of the blade assembly causes all four synchronising shafts to rotate at the same rate as the blade assembly.

By placing the modules adjacent to each other, the synchronising shafts of adjacent modules may be brought into engagement at their exposed ends. For example, a synchronising shaft 6d is exposed at recess 5d and this may be brought into engagement with a corresponding synchronising shaft 6e (which is invisible in FIG. 1) in recess 5e. This is shown in more detail in FIG. 2.

The coupling between the synchronising shafts within the housings 1a to 1f will be explained in more detail later, but it should be clear from this explanation that this arrangement of coupling synchronising shafts between adjacent modules ensures that the blade assemblies of all the modules making up a module assembly rotate at the same rate and remain in alignment with each other. This in turn ensures that the image displayed is as required (i.e. that the overall image is not distorted, which would occur if adjacent modules ran at different speeds) and that the blade assemblies 2a to 2f of adjacent modules cannot crash into each other.

It is important to realise that the driving power for the blade assemblies 2a to 2f is provided by a respective motor mounted within each housing 1a to 1f as explained later. The synchronising shafts simply ensure that the blade assemblies 2a to 2f all rotate in synchrony and help overcome any slight differences in speed between adjacent blade assemblies 2a to 2f. However, should a motor fail the adjacent motors can continue to drive the blade assembly normally driven by that motor without a significant deterioration in image quality.

The ends of the synchronising shafts 6d and 6e are keyed as shown in FIG. 2 such that rotation of one is transmitted to the other. The synchronising shafts 6d and 6e are spring loaded to urge them into engagement with those of other modules in a module assembly. The synchronising shafts 6d and 6e may be drawn back against the spring tension so that the keyed portions lie entirely within recesses 5d and 5e (as shown in FIGS. 1 and 2) to enable each module to be placed in position or removed from its position without disturbing adjacent modules in an assembly. The mechanism for achieving this is not shown in the drawings.

Each module has a separate connection to mains power, with a switch-mode power supply present in each module to convert the alternating current mains supply into suitable DC voltages.

As already mentioned, each display module has its own respective motor 16d which provides the motive force for driving the blade assemblies 2a to 2f. The motors are typically stepper or brushless DC motors, and are caused to rotate at the same speed by energising the phases of the motors in synchrony with a master clock signal supplied to each of the modules.

Thus, the motors all rotate at the same speed, and the synchronising shafts 6d, 6e merely operate to ensure positional synchronisation between adjacent modules and to prevent any slight disparity in speed between adjacent modules, which may occur during acceleration at initial power-up or deceleration when the modules are powered-down. Also, the synchronising shafts 6d, 6e can supply motive force to a module if its motor has stopped operating for some reason.

Video data is typically supplied from a personal computer (PC) running media player software, such as the VLC media player from VideoLAN. The streamed video output is typically fed from the Digital Visual Interface (DVI) connector on the PC's video adapter to a central display controller PCB, which reformats the video data to the correct size to fill the area swept out by the blade assemblies 2a to 2f of each module in the module assembly. The central display controller PCB then serialises the reformatted video data and supplies the serial data to each of the display modules via a daisy-chain video link.

Each display module therefore receives the same serial video data from the central display controller. The display modules are all provided with an array of switches which allow the module's address, which defines its relative position within the assembly, to be set. When the address has been set, each display can then extract and display only the relevant portion of the serial video data. In this way, the display module assembly displays a composite image in which each display module displays only its respective portion of the overall image.

FIG. 3 shows the coupling between the synchronising shafts which is located within each housing 1a to 1f. In particular, FIG. 3 shows how synchronising shafts 6d, 7d, 8d and 9d each have a respective bevel gear 10d, 11d, 12d and 13d on their inner end. Each of these bevel gears 10d, 11d, 12d and 13d meshes with another bevel gear 14d such that rotation of any one synchronising shaft 6d, 7d, 8d or 9d causes rotation of the other three synchronising shafts. Bevel gear 14d is mounted on shaft 15d which at one end is connected to motor 16d and at the other end is connected to blade assembly 2d. In this way, rotation of any synchronising shaft 6d, 7d, 8d, 9d will cause rotation of the other three synchronising shafts and the blade assembly 2d. Furthermore, motor 16d may be driven to cause rotation of all four synchronising shafts 6d, 7d, 8d and 9d and the blade assembly 2d. Therefore, the blade assembly 2d may be caused to rotate either by motor 16d or by rotation of one of synchronising shafts 6d, 7d, 8d, 9d by virtue of that synchronising shaft being coupled with the synchronising shaft of an adjacent display module. However, as already explained, motive force will only be provided to blade assembly 2d via one of the synchronising shafts 6d, 7d, 8d, 9d in the event of a malfunction of motor 16d.

FIGS. 4 and 5 show the display module assembly of FIG. 1 in which the configuration of the display modules has been completed such that they are now ready for use as a “six-sheet” display. Specifically, the blade assemblies 2b, 2d and 2f have been rotated relatively to the blade assemblies 2a, 2c and 2e so that the blade assembly of any one module is offset rotationally by 45° with respect to the blade assemblies of all adjacent modules. For example, the blade assembly 2d is offset by 45° with respect to blade assemblies 2a and 2e, and the blade assembly 2b is offset by 45° with respect to blade assemblies 2a, 2c and 2e.

To achieve this offset, the blade assembly 2d of a module must be rotated without rotating the associated synchronising shafts so that the synchronising shafts will still remain in alignment with those of adjacent modules. Therefore, a clutch mechanism (not shown) is provided which can be actuated to decouple the blade assembly 2d from shaft 15d. With the clutch actuated the blade assembly can be rotated to its desired position and the clutch can then be released to engage the blade assembly 2d with shaft 15d again. The clutch mechanism is typically arranged so that it can be released only when the blade assembly is suitably positioned (i.e. either at 0° or 45° offset).

This offsetting is necessary to ensure that all of the blade assemblies 2a to 2f can rotate simultaneously without collision. As can be seen from the arrows superimposed in FIG. 5 the blade assembly of each module rotates in an opposite direction to those of the adjacent modules.

FIG. 6 shows a detailed view of part of blade assembly 2d. As can be seen, this is made from a metal (typically aluminium or aluminium alloy) or plastic extrusion 17. A printed circuit board (PCB) 18 is mounted in the extrusion 17 by sliding it into two channels 19 and 20 integral with the extrusion 17. The PCB is retained in position by mounting screws.

The PCB 18 and the extrusion 17 both have respective pointed ends 21 and 22, and the array of LEDS, forming one end of line 4d, mounted on PCB 18 runs down the centre line of PCB 18 into the pointed end such that the outermost LED of line 4d aligns with the corners of housing 1d as the blade assembly 2d rotates. This ensures that the total surface of the front face of housing 1d is swept over by the line of LEDs 4d (and of course the line 3d) as the blade assembly 2d rotates.

FIG. 7 shows a close up view of the centre of blade assembly 2d. In this view, it can be seen that the blade assembly 2d houses five PCBs, four of which (18, 23, 24 and 25) are housed in channels in the extrusion, and a central PCB 26 which is screw-mounted on the blade assembly 2d at the intersection of the four PCBs 18, 23, 24 and 25. This central PCB 26 is required to ensure that the two lines of LEDs 3d and 4d carry on right through the centre, crossing at centre point 27.

The LEDs on PCBs 23 and 25 and the LEDs on central PCB 26 which form part of line 3d are positioned so that they will interlace with the LEDs on PCBs 18 and 24 and the LEDs on central PCB 26 which form part of line 4d. Thus, the two lines 3d and 4d form interlacing lines as the blade assembly 2d rotates.

FIG. 8 shows a second type of module in which the synchronisation of the rotation of the blade assemblies is carried out electronically rather than by a mechanical linkage as in the module shown in FIGS. 1 to 7.

In FIG. 8, there is shown a frame 300 on which is rotatably mounted a blade assembly 301 and a peripheral ring gear 302. As with the embodiment shown in FIGS. 1 to 7, the blade assembly comprises four PCBs 303a to 303d arranged as in the blades of a fan and a centre PCB 303e. A first line of tricolour LEDs extends from the tip of PCB 303a through centre PCB 303e to the tip of PCB 303c. A second line of tricolour LEDs extends from the tip of PCB 303b through centre PCB 303e to the tip of PCB 303d. The two lines therefore form a cross with the centre at the rotational centre of the blade assembly on centre PCB 303e. The LEDs forming the first line are radially offset from those of the second line such that the LEDs of the first line are interlaced with those of the second line. Therefore, as the blade assembly rotates the LEDs each describe a respective unique circular path.

FIG. 9 shows a sectional view through part of the module of FIG. 8. In particular, it shows the structure of the motor. The motor comprises a stator 304 and a rotor 305. The stator 304 is an integral part of the frame 300. The rotor 305 is rotatably mounted on a hollow shaft 306 which is fixed to stator 304. The stator 304 carries field windings 307 and the rotor 305 carries a set of permanent magnets 308. By energising the field windings 307 with appropriate currents, the rotor 305 can be caused to rotate around the shaft 306.

Power is typically coupled from the stationary part of the module to the rotating parts (i.e. the LEDs etc.) by slip rings (not shown).

As the motor rotates, high speed image data is received by an optical transmitter mounted on a communications PCB from a remote video interface PCB via a coaxial cable. The optical transmitter is in optical communication with an optical receiver mounted on the underside of centre PCB 303e. The optical transmitter and receiver are aligned with the central axis of the hollow shaft 306 so that image data can be conveyed to the centre PCB 303e. The centre PCB 303e then modulates the intensity and/or wavelength of light emitted by each of the LEDs on the centre PCB 303e as well as PCBs 303a to 303d as the rotor rotates.

FIG. 10 shows the rotor 305 in isolation. The rotor 305 comprises a circular ring of castellations 309. The ring of castellations 309 runs between an optical transmitter and receiver (not shown) mounted on a control PCB on the stator 304. As the rotor 305 rotates relative to the stator 304, each castellation passes between the transmitter and receiver in turn and obscures a beam of light transmitted by the transmitter. The passage of the leading edge of a castellation into the space between the optical transmitter and receiver is detected by the optical receiver, which produces a rising edge (or falling edge, if appropriately configured) in its output signal in response. Conversely, the passage of the trailing edge of a castellation out of the space between the optical transmitter and receiver is detected by the optical receiver, which produces a falling edge (or rising edge, if appropriately configured) in its output signal in response. Thus, the passage of the castellations between the optical transmitter and receiver causes a pulse train to be generated in the output signal from the optical receiver.

This pulse train is used for the purpose of synchronising the rotational speed and offset (relative to an absolute synchronisation point) of the display module. Synchronisation occurs against a master clock signal supplied to all of the display modules (either in parallel or in a serial daisy chain). It is important that synchronisation is performed against either the rising or the falling edges in the pulse train to ensure accuracy as it is unlikely that there will be a consistent mark:space ratio between pulse trains produced by different modules or even within the pulse train produced by one module.

The number of castellations in the circular ring 309 is chosen to be an odd multiple of the number of teeth in the ring gear 302 (discussed below). A typical example is three time the number of teeth in the ring gear 302 or 168 castellations. This is a sufficient number of castellations to allow accurate control of the speed and offset from the absolute synchronisation point. It is also divisible by 3, 4, 6, 7, 8, 12, 14, 21, 24, 42 and 56 so that the number of castellations can be easily mapped on to the number of poles of the motor to simplify the motor controller design.

The absolute synchronisation point is provided by omitting one of the castellations in the circular ring 309. This “missing castellation” is still counted as one of the 168 castellations mentioned above. It causes a long space (or long mark, if appropriately configured) region to appear in the pulse train.

Circuitry on the control PCB compares the pulse train from the receiver with the remotely generated master clock signal and outputs a correction signal to a speed controller. The speed controller varies the speed of rotation of the rotor 305 by adjusting the signals supplied to the field windings on the stator 304 so that the rising (or falling) edges in the pulse train generated by the receiver are synchronised with those of the master clock signal. In this way, it is possible to ensure that a plurality of display modules all rotate in synchrony with the master clock and therefore all rotate at the same speed as each other.

The master clock signal also has a “missing pulse” every 168 pulses. This is used to ensure positional offset synchronisation of the display module by ensuring that the long space in the pulse train from the receiver is synchronised with the “missing pulse”. Alternatively, a number of edges may be counted in the pulse train after the space region, at which point synchronisation occurs with the “missing pulse” to allow an offset in rotational position to be achieved. Thus, adjacent modules can be caused to rotate with different offsets, but at the same speed.

Each of the modules is provided with a set of two switches, which is used to identify to the module what positional offset from the absolute synchronisation point it should adopt as it rotates and which direction it should rotate in. The switches may be simple mechanical switches or jumpers. Alternatively, a memory device may be programmed to identify the offset that should be adopted. There are four possible variations, which are set out in the table below. The four variations are used to set the offsets for display modules in groups of four modules arranged in a square configuration. Blocks of four modules can then be placed adjacent each other and having the same configuration as the adjacent block of four modules. Of course, fewer than four modules may be placed in a block if a desired assembly cannot be made from a multiple of four modules; the missing modules are simply not configured. This allows any size and shape of display assembly to be created.

| | X Switch Closed | X Switch Open |
|---|---|---|
| Y Switch | Disc address (0, 1) | Disc address (1, 1) |
| Open | Rotate Anticlockwise | Rotate Clockwise |
| | Offset 67.5 degrees from the | Offset 45 degrees from the |
| | absolute sync point | absolute sync point |
| | Sync point is 136 edges after | Sync point is 21 edges after |
| | the absolute sync point | the absolute sync point |
| Y Switch | Disc address (0, 0) | Disc address (1, 0) |
| Closed | Rotate Clockwise | Rotate Anticlockwise |
| | Offset 0 degrees from the | Offset 67.5 degrees from the |
| | absolute sync point | absolute sync point |
| | Sync point is at the absolute | Sync point is 31 edges after |
| | sync point | the absolute sync point |

As can be seen, adjacent display modules rotate in opposite senses and are offset from each other by an odd multiple of 22.5°.

FIG. 11 shows the stator 304 in isolation. This has integral interlocking elements, which enable a plurality of modules to be built up into a display assembly as shown in FIG. 12. The interlocking elements comprise a first pair of male members 310a and 310b on a first corner of the stator 304 and a second pair of male members 311a and 311b on a second diagonally opposed corner of the stator 304. There is also a first pair of female members 312a and 312b on a third corner of the stator 304 and a second pair of female members 313a and 313b on a fourth diagonally opposed corner of the stator 304.

The male member 310a on a first module can be engaged with female member 312a on a second module, and male member 310b can be engaged with female member 313a on a third module. Similarly, female member 312b may be engaged with male member 311a on the third module, and female member 313b may be engaged with male member 311b on the second module. By connecting multiple modules in this manner a composite array of display modules can be constructed as shown in FIG. 12. The interlocking elements 310a, 310b, 311a, 311b, 312a, 312b, 313a and 313b of each of the modules ensures that the correct registration and relative orientation of the modules in the assembly is maintained. The modules are fixed in place by securing them to a framework with a bolt passed through the central holes in the male members 310a, 310b, 311a and 311b.

By providing each module in the assembly with appropriate image data, the modules as a whole may be caused to display a composite image, each module displaying a respective portion of the composite image.

When an assembly is constructed, the teeth of the ring gears 302 of adjacent modules interdigitate. The teeth have a normal involute tooth profile with a small amount of material removed around the whole tooth. Thus, when the rotors 305 of adjacent modules are running in synchrony, the gear teeth of adjacent ring gears 302 do not make contact. This results in lower noise and hence lower power operation. The ring gears 302 are provided to ensure that the PCBs 303a to 303d of a first module do not collide with those of adjacent modules in the event that a fault develops on the first module which causes it to rotate asynchronously with the adjacent modules. One type of fault which may cause this is failure of a motor. In this event, the ring gear 302 of the first module will make contact with the ring gears 302 of the adjacent modules, and the ring gears 302 of the adjacent module will drive the ring gear 302 of the first module, thereby ensuring that the fault is not catastrophic. Indeed, the first module will continue to operate as if the fault had not occurred.

The ring gears 302 are also used to prevent collisions during acceleration and deceleration of the motors of the modules in an assembly during initial power-up and power-down operations.

The number of teeth in the ring gears 302 is chosen with two main criteria in mind. Firstly, the offset in angular displacement between adjacent display modules should be chosen to maximise the minimum distances between the PCBs 303a to 303d of adjacent and diagonally juxtaposed modules. We have found that an offset of odd multiples of 22.5° is optimal; an offset of even multiples of 22.5° (i.e.) 45°) causes the PCBs 303a to 303d on diagonally juxtaposed modules to pass with only a tiny separation so that any slight misalignment could result in a collision. Secondly, the teeth need to be sufficiently robust to withstand becoming enmeshed if a motor in a module should fail.

To provide the offset of odd multiples of 22.5°, the number of teeth must be equal to

$$\frac{360}{22.5} n + 8 ,$$

where n is a non-negative integer. In practice, we have found that 56 teeth is a suitable number to satisfy both criteria.

If a fault should develop, each module may be replaced individually. This is due to the shape of the interlocking elements 310a, 310b, 311a, 311b, 312a, 312b, 313a and 313b which allow the modules to be slid inwardly and outwardly relative to the adjacent modules and perpendicularly to the plane of rotation of PCBs 303a to 303d. FIG. 13 shows a module in which each of the PCBs 303a to 303d have been folded inwardly to allow the module to be withdrawn without interfering with the adjacent modules. Each PCB 303a to 303d is rotatably mounted on a respective guide channel 320a to 320d. When each of the PCBs 303a to 303d is aligned with its respective guide channel 320a to 320d (as shown in FIG. 8), the PCB 303a to 303d is urged by a respective spring (not shown) to fall into the respective guide channel 320a to 320d where the sides of the guide channel 320a to 320d hold the PCB 303a to 303d in the correct position. The PCBs 303a and 303d can be pulled out of the guide channels 320a to 320d against the springs and rotated to the positions shown in FIG. 13.

FIG. 19 shows a block diagram of the electronic circuitry in the display module of the second embodiment of FIGS. 8 to 13. The diagram shows both the rotating section of the display module on one side of the dashed line and the static section on the other side of the dashed line.

In the static section, there is a motor control PCB 400. This receives the master clock signal synchronisation pulses and a 48 volt, 12 ampere power supply for driving the motor and display circuitry (including the LEDs). The motor control PCB energises the field windings 307 of motor 401. The motor 401 comprises stator 304, which carries the field windings 307, and rotor 305, which carries a set of permanent magnets 308 as already explained above. As the motor rotates the ring of castellations 309 on rotor 305 runs between the optical transmitter and receiver, as discussed above. The optical transmitter and receiver together form an optical sensor 402. The pulse train generated by the sensor 402 is supplied to motor control PCB 400 so that the speed and offset of rotation of the display module can be maintained at desired values under feedback control.

The motor control PCB 400 also supplies power via slip rings 403 to a rotating power supply unit (PSU) 404. This carries set of voltage regulators to supply the PCBs 303a to 303d and centre PCB 303e with voltages of 5 volts, 4.5 volts and 3.3 volts.

Centre PCB 303e also receives a video signal (labelled “VIDEO IN” on FIG. 19) which provides the static or moving image to be displayed by the LEDs on PCBs 303a to 303d and centre PCB 303e as they rotate. The display module is configured before commissioning to know its position within an array so that it can extract the relevant portion of the image data conveyed by the video signal. Thus, the display assembly as a whole shows a composite image defined by each of these portions. The same video signal is supplied to all the display modules within an assembly (either in parallel or by daisy chaining the signal from one display to the other).

An optical sensor comprising an optical transmitter and receiver is mounted on the rotor 305. As the sensor rotates an associated element on stator 304 interrupts the beam of light between the optical transmitter and receiver and causes a pulse to be generated. The centre PCB 303e uses this pulse to determine when each revolution starts. Since the speed of rotation is known, the centre PCB 303e can calculate the position of the PCBs 303a to 303d and itself and cause the correct signals to be sent to the LEDs so that the correct pixels of the image are displayed.

Centre PCB 303e is also provided with a transmitter and receiver for handling serial diagnostic data. This can be used by centre PCB 303e for providing diagnostic information to a remote controller. This information can be useful for fault condition and environmental monitoring. It is a bidirectional serial link and can be used for the uploading of new firmware of filed programmable gate array (FPGA) images to the centre PCB 303e.

As is evidently apparent from the preceding figures, the surface swept out by the LEDs in both the first and second embodiment is circular. In both cases, the circular area swept out by each display module overlaps which those of the adjacent modules to ensure that the entire surface of the display assembly formed from the combined modules is swept out so that no black spots are visible in the overall image. However, it will be appreciated that rather than generating a circular format display, it is normally required to generate one that is rectangular or square in format. Two different techniques are envisaged for achieving this, the first being a mechanical modification to the display modules of the first and second embodiments described above, and the second involving an electronic technique for mapping the data onto the arrays of LEDs such that the image generated appears to be square or rectangular as required.

A display device for carrying out the first of these techniques is shown in FIG. 14. In FIG. 14, the display device 100 has a shaft 101 which is driven by a motor (not shown) or other source of drive power. The shaft 101 is coupled to a display PCB assembly comprising PCBs 102 and 103 and a central PCB 104. On each of PCBs 102 and 103 there is slidably mounted an auxiliary PCB 105 and 106 respectively. PCBs 102 and 103 each carry a respective array of LEDs 107a and 108a, and the auxiliary PCBs 105 and 106 carry corresponding arrays 107b and 108b. The arrays 107b and 108b appear to extend the arrays 107a and 108a. As the PCBs 102 and 103 rotate on shaft 101 the auxiliary PCBs 105 and 106 may be extended and retracted as appropriate in order to cause a square image to be generated. Even though the LEDs in arrays 107a and 108a describe a circular path, by adjusting the profile of extension and retraction of auxiliary PCBs 105 and 106, an overall square image may be generated.

One way of controlling the extension and retraction of auxiliary PCBs 105 and 106 is shown in FIG. 15. A cam 109 acts on cam followers 110 and 111 as the auxiliary PCBs 105 and 106 rotate on shaft 101. In FIG. 15, the PCBs 102 and 103 and auxiliary PCBs 105 and 106 are shown in four positions labelled I, II, III and IV respectively. In position I, the auxiliary PCBs 105 and 106 are retracted fully, thereby lying underneath PCBs 102 and 103. In position II, the cam profile forces the cam followers 110 and 111 radially outwards so as to force auxiliary PCBs 105 and 106 correspondingly radially outwards. Positions III and IV are similar to positions I and II respectively. Auxiliary PCBs 105 and 106 are urged towards their retracted positions (for example, by springs) so that the cam followers 110 and 111 follow the profile of cam 109 closely. The auxiliary PCBs 105 and 106 therefore retract automatically when not forced into the extended position by the profile of cam 109.

By causing the auxiliary PCBs 105 and 106 to extend and retract in this manner it can be seen that whilst the outermost LEDs on PCBs 102 and 103 follow a circular path 112, the outermost LEDs on auxiliary PCBs 105 and 106 follow an approximately square path 113. The exact shape of path 113 depends on the profile of cam 109. It need not be square or rectangular, but can be almost any shape.

FIGS. 16a and 16b show the PCBs 102 and 103 and auxiliary PCBs 105 and 106 from above in different positions as they rotate. FIG. 10a shows positions corresponding to position II on FIG. 15 in which the auxiliary PCBs 105 and 106 are fully extended in order to cause the image generator to be square, whilst FIG. 10b shows the auxiliary PCBs 105 and 106 in a fully retracted position (corresponding to positions I and III of FIG. 15) in which the auxiliary PCBs 105 and 106 are fully hidden behind PCBs 102 and 103 respectively.

Instead of making use of cam 109, the auxiliary PCBs 105 and 106 may be extended and retracted using a motor (not shown) which drives a pair of lead screws or ball screws (not shown) disposed in diametrical opposition underneath PCBs 102 and 103. The nuts on the lead screws, or ball cages on the ball screws, are coupled to the auxiliary PCBs 105 and 106 so that the radial displacement of the auxiliary PCBs 105 and 106 can be varied. A controller monitors the angular displacement of the auxiliary PCBs 105 and 106 as they rotate and provides the motor with suitable signals to drive the lead screws or ball screws so that the outermost LEDs on auxiliary PCBs 105 and 106 follow the desired profile of path 113.

The method of the second technique is shown in FIG. 17. The method is typically carried out by a suitably configured electronic circuit comprised within the controller. The method will be described with reference to only one of the display modules shown in FIG. 1, but it should be appreciated that the same method is used on each of the display modules making up a display module assembly, and is also of course applicable to the display modules of the second embodiment.

The method starts in step 200 by monitoring the position of the blade assembly 2a, and therefore the position of the LEDs forming lines 3a and 4a.

An image boundary is predefined to correspond to the shape and size of the front face of housing 1a. In step 201, the point of intersection of the lines of LEDs 3a and 4a with this image boundary is calculated.

The controller then proceeds to fetch image data values for each virtual pixel which corresponds to the LEDs in line 3a and 4a in step 202.

For those LEDs in line 3a and 4a which fall within the image boundary the intensity 30 and/or colour of the light emitted by those LEDs is modulated in accordance with the image data values so as to display the portion of the desired image corresponding to the particular display module. This occurs in step 203.

However, for LEDs in lines 3a and 4a falling outside the image boundary the intensity of the illumination of the LEDs in line 3a and 4a is modified by multiplying the data values by zero such that no light is emitted by these LEDs. This occurs in step 204. This ensures that the size and shape of the image generated by the display module overlays the front face of display module 1a exactly and the display module does not generate any portion of the desired image where the blade assembly 2a overlaps other adjacent display modules.

FIG. 18 shows a variant of this technique. The variant is identical from steps 200 to 203. However, step 204 is replaced by a new step 205 in which the LEDs in lines 3a and 4a falling outside the image boundary are gradually dimmed depending on the distance of the particular LED from the image boundary such that at the ends of lines 3a and 4a, the intensity of illumination is zero. This has the effect of merging the portions of the images created by two adjacent displays in the region where the blade assemblies 2a overlap.

In another variant, the LEDs in lines 3a and 4a falling outside the image boundary may be driven so that they display pixels at half brightness. Thus, the visible pixels resulting from the overlap of the blade assemblies 2a of adjacent displays appear at the normal brightness.

1.-90. (canceled)

91. A display module comprising at least one light source movable along a predetermined path and a controller adapted to modulate the intensity of light emitted by the at least one light source as it moves along the predetermined path so as to cause a desired image to be visible by virtue of persistence of vision, the display module further comprising a drive system for causing the at least one light source to move along the predetermined path and a coupling system adapted to ensure that the drive system causes the at least one light source to move, in use, along the predetermined path in synchrony with the light sources on one or more adjacent display modules, characterised in that the drive system comprises a plurality of synchronising shafts coupled together and to the at least one light source such that rotation of any one synchronising shaft causes the others to rotate and the at least one light source to move along the predetermined path and the coupling system comprises a coupling on each synchronising shaft, whereby each synchronising shaft can be coupled, in use, to a synchronising shaft of an adjacent display module, thereby ensuring that the light sources on each module move in synchrony.

92. A display module according to claim 91, wherein the synchronising shafts are coupled together and to the at least one light source by a gear linkage, the gear linkage comprising a plurality of bevel gears, each of which is mounted on one end of a respective one of the plurality of synchronising shafts and is meshed with another bevel gear coupled to the at least one light source.

93. A display module according to claim 91, wherein the at least one light source is coupled to the plurality of synchronising shafts via a clutch such that when the clutch is disengaged the at least one light source may move along the predetermined path without corresponding movement of the plurality of synchronising shafts, and the clutch may only be engaged when the at least one light source is at one of a plurality of index positions along the predetermined path and the plurality of synchronising shafts are at a predetermined angle of rotation.

94. A display module according to claim 91, further comprising a housing in which the plurality of synchronising shafts are mounted, the housing comprising a front face and at least one peripheral face defining the perimeter of the housing, wherein an end of each synchronising shaft is exposed through a respective aperture in the at least one peripheral face, the front face and at least one peripheral face being disposed at right angles, and the front face of the housing being shaped such that a plurality of housings may be placed with their peripheral edges in abutment to form a tessellation.

95. A display assembly comprising a plurality of display modules according to claim 94, wherein the peripheral edges of each display module are placed in abutment with those of adjacent display modules to form a tessellation, and the synchronising shafts of each display module are coupled such that the light sources of each display module all rotate in synchrony.

96. A display module comprising at least one light source movable along a predetermined path and a controller adapted to modulate the intensity of light emitted by the at least one light source as it moves along the predetermined path so as to cause a desired image to be visible by virtue of persistence of vision, the display module further comprising a drive system for causing the at least one light source to move along the predetermined path and a coupling system adapted to ensure that the drive system causes the at least one light source to move, in use, along the predetermined path in synchrony with the light sources on one or more adjacent display modules, characterised in that the drive system comprises a motor coupled to the at least one light source and the coupling system comprises a speed controller for controlling the speed of rotation of the at least one light source and/or the angular offset of the at least one light source relative to an absolute synchronisation point in accordance with a master clock signal.

97. A display module according to claim 96, further comprising a first sensor adapted to generate an output pulse in response to the passage of each of an array of circumferentially-spaced speed control elements as the at least one light source rotates, the speed control elements being equidistantly spaced from each other, wherein the speed controller is adapted to control the speed of rotation of the motor such that the output pulses generated by the sensor and the master clock signal are synchronised.

98. A display module according to claim 97, wherein the array of circumferentially-spaced speed control elements comprises a gap equal to the size of one of the speed control elements between two adjacent speed control elements such that the passage of the gap through the first sensor generates an extended pulse, the speed controller being further adapted to control the angular offset of the at least one light source relative to the absolute synchronisation point by synchronising the extended pulse with an extended pulse in the master clock signal.

99. A display module according to claim 96, further comprising a second sensor for detecting the passage of a location element, thereby enabling each revolution of the at least one light source to be detected.

100. A display module according to claim 96, further comprising a peripheral ring of gear teeth coupled to the motor, which interdigitate in use with the gear teeth on the rotors of adjacent modules, the gear teeth being configured such that they do not make contact in use with the gear teeth of adjacent modules when the light sources of adjacent modules are rotating in synchrony.

101. A display module according to claim 96, further comprising interconnection features for interconnecting the display module with adjacent display modules in a predefined registration and orientation, the interconnection features comprising a pair of male features on each of a first pair of diagonally opposed corners of the module and a pair of female features on each of a second pair of diagonally opposed corners of the module, whereby the male and female features cooperate with the female and male features respectively on adjacent modules to hold the adjacent modules in the predefined registration and orientation.

102. A display assembly comprising a plurality of display modules according to claim 101, wherein the interconnection features of each display module are interconnected with those of adjacent modules, and each display module is supplied with the master clock signal such that the light sources of each display module rotate in synchrony.

103. A display assembly according to claim 95, wherein a controller of each display module is electrically connected to a controller of an adjacent display module to enable transmission of image data from each display module to the adjacent display module.

104. A display assembly according to claim 95, wherein the position of the at least one light source of each display module is offset along its respective predetermined path relative to the position of the at least one light source of adjacent display modules.

105. A display assembly according to claim 95, wherein each display module may be slidably moved in a direction perpendicular to the plane in which the predetermined path lies relative to adjacent display modules, thereby enabling replacement of the module.
